(19) United States
(12) Patent Application Publication
(10) Pub. No.: US 2015/0068908 A1
(43) Pub. Date: Mar. 12, 2015

(54) GALVANIC BATH FOR THE ELECTROLYTIC DEPOSITION OF A COMPOSITE MATERIAL

(71) Applicant: Pierre-Antoine Gay, Villers-Le-Lac (FR)

(72) Inventor: Pierre-Antoine Gay, Villers-Le-Lac (FR)

(73) Assignee: HAUTE ECOLE ARC, Neuchatel (CH)

(21) Appl. No.: 14/389,794

(22) PCT Filed: Apr. 2, 2013
(86) PCT No.: PCT/EP2013/056939

§ 371 Date: Oct. 1, 2014

(30) Foreign Application Priority Data
Apr. 2, 2012 (CH) 00459/12

(51) Int. Cl. C25D 15/00; C25D 3/56

(52) U.S. Cl. CPC C25D 15/00; C25D 3/56; B82Y 30/00
USPC 205/50; 205/109; 977/902; 977/752; 977/778; 977/832

(57) ABSTRACT

A galvanic bath for the electrolytic deposition of a composite material based on gold, copper and cadmium, including gold, copper and cadmium as cyanide, has a pH higher than 7, and further includes carbon nanotubes, and does not contain any surfactant used to disperse the carbon nanotubes. A method for the galvanic deposition of a composite material on a substrate, includes the steps of preparing such a bath and ultrasound treatment of the bath, and does not include any step of thermal pre-treatment of the bath.

### TECHNICAL FIELD

The present invention relates to galvanic baths for the electrolytic deposition of a composite material based on gold, copper and cadmium, comprising, in a cyanide form, gold, copper and cadmium. It also relates to a method for galvanic deposition of a composite material on a substrate, as well as to a part comprising a coating with such a composite material.

### STATE OF THE ART

Alloys based on gold, copper and cadmium comprising preferably more than 50% of gold, are used in many fields, notably in the field of clockmaking for decoration, jewelry or electronics for producing contacts.

These alloys may be deposited on a substrate via the galvanic route by means of a galvanic bath in which is placed a substrate.

Research is still conducted for improving the properties of these alloys depending on their fields of use. Notably, it is necessary to reduce the friction coefficient or the resistivity in order to increase the electric conductivity of the alloy.

A solution for depositing a copper layer via a galvanic route with improved properties is for example described in publications WO 2008/063148 or US 2007/0199826. These documents describe the preparation of a galvanic bath based on copper and on single-walled carbon nanotubes, in an acid medium in order to obtain a deposition of a composite material. However, these publications describe baths comprising many additives, which may generate parasitic reactions which are detrimental to the properties of the deposited composite material. Further, if the additives present in the bath degrade, the bath may no longer operate and has to be replaced. Moreover, the known methods used many pretreatments of the bath, such as heat treatments which are energy consuming.

Accordingly, an object of the present invention is to propose a galvanic bath with which it is possible to obtain a material based on gold, copper and cadmium with improved properties.

Another object of the present invention is to propose a method for galvanic deposition of a material based on gold, copper and cadmium, which is simple and economical.

### DISCLOSURE OF THE INVENTION

For this purpose, and according to the present invention, a galvanic bath is proposed for electrolytic deposition of a composite material based on gold, copper and cadmium, comprising in a cyanide form, gold, copper and cadmium.

According to the invention, said galvanic bath has a pH greater than 7, and further comprises carbon nanotubes. Further, it does not contain any surfactant used for dispersing carbon nanotubes.

The present invention also relates to a method for galvanic deposition of a composite material on a substrate comprising the steps:
preparation of a bath as defined above,
treatment of said bath with ultrasound,
electrolysis in said bath comprising an anode and the substrate forming a cathode,
   said method not comprising any thermal pretreatment step of the bath.

The present invention also relates to a part having an electric resistivity of less than 10 mΩ, comprising a galvanic coating of a composite material comprising between 55% and 80% by weight of gold, between 10% and 30% by weight of copper, between 5% and 10% by weight of cadmium and between 0.1% and 5% by weight of carbon nanotubes, based on the total weight of the composite material.

Said part may comprise a sub-layer comprising nickel and between 1% to 20% by weight of phosphorus, and having been subject to a heat treatment and a temperature comprised between 200° C. and 500° C.

### SHORT DESCRIPTION OF THE DRAWINGS

The invention will be better understood upon reading the description which follows, of an embodiment, given as an example and made with reference to the drawings wherein:

FIGS. 1 and 2 illustrate the friction coefficient for a gold and cobalt deposit with and without carbon nanotubes, and for a gold, copper and cadmium deposit with and without carbon nanotubes, respectively, and

FIGS. 3 and 4 illustrate the resistivity for a gold and cobalt deposit with and without carbon nanotubes, and for a gold, copper and cadmium deposit, with and without carbon nanotubes respectively.

### EMBODIMENT(S) OF THE INVENTION

A galvanic bath is described for the electrolytic deposition of a composite material based on gold, copper and cadmium, comprising in a cyanide form, gold, copper and cadmium. According to the invention, said galvanic bath further comprises carbon nanotubes.

Preferably, the carbon nanotubes are multi-walled carbon nanotubes. Advantageously, they have a length comprised between 0.5 μm and 10 μm, and a diameter comprised between 5 nm and 20 nm. Preferably, they have a length comprised between 0.5 μm and 10 μm, and a diameter comprised between 7 nm and 15 nm.

Preferably, the galvanic bath according to the invention contains from 0.5 g/l to 20 g/l of gold metal, and more preferentially from 3.5 g/l to 8 g/l of gold metal, 6 g/l to 70 g/l of copper metal and more preferentially from 20 g/l to 35 g/l of copper metal, from 0.3 g/l to 5 g/l of cadmium metal, and more preferentially from 0.6 g/l to 1.5 g/l of cadmium metal and from 0.5 g/l to 20 g/l of carbon nanotubes, and more preferentially from 0.5 g/l to 15 g/l of carbon nanotubes, so as to obtain a composite material comprising between 55% and 80% by weight of gold, between 10% and 30% by weight of copper, between 5% and 10% by weight of cadmium, and between 0.1% and 5% by weight of carbon nanotubes, based on the total weight of the composite material.

Preferably, the obtained composite material comprises between 55% and 75% by weight of gold, between 15% and 25% by weight of copper, between 8% and 10% by weight of cadmium, and between 0.1% and 5% by weight of carbon nanotubes, based on the total weight of the composite material.

In a particularly advantageous way, the metal species are used in a cyanide form, so that according to the invention, said galvanic bath has a pH of more than 7. Preferably, the pH of the galvanic bath according to the invention is greater than 9, and more preferentially is comprised between 9 and 11, and still more preferentially comprised between 9.5 and 10.5, with preferably a current density from 0.6 A·dm² to 1.5 A·dm² and at a temperature of 45° C. to 75° C., preferentially between 60° C. and 65° C.

The galvanic bath according to the invention may further comprise from 3 g/l to 50 g/l of free potassium cyanide, and preferably from 20 g/l to 30 g/l of free potassium cyanide, so that the total amount of cyanide is comprised between 1 and 200 g/l.

The galvanic bath may also comprise an organic complexing agent, of the hydroxy-alkyl-amino-dicarboxvlic type of general formula

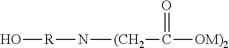

wherein R represents an alkylene group with 1 to 4 carbon atoms and M represents ions selected from the group comprising sodium, potassium and ammonium ions, in an amount comprised between 5 g/l and 100 g/l.

The galvanic bath may also comprise a wetting agent, such as amido-propyl-dimethyl-aminoxides of fatty acids according to the following general formula.

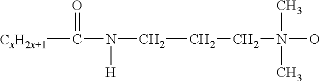

wherein X represents a number comprised between 11 and 17 in an amount between 0.01 ml/l and 50 ml/l.

The galvanic bath may also comprise an inorganic brightener in the form of soluble salts or complexes of selenium, tellurium, vanadium, arsenic, or their mixture, in an amount comprised between 0.01 mg/l and 100 mg/l.

The galvanic bath may also comprise a depolarizer, such as sodium thiosulfate or derivatives of thioalkane sulfonic or thiocarboxylic acids, such as for example mercaptosuccinic acid, in an amount comprised between 2 mg/l and 20 mg/l.

The obtained galvanic bath preferably has a density in degrees Baumé comprised between 12° Baumé and 32° Baumé, and preferably comprised between 12° Baumé and 20° Baumé.

Thus, a galvanic bath according to the invention may contain:
from 1 g/l to 20 g/l of gold in the form of a cyanide complex,
from 6 g/l to 70 g/l of copper in the form of a cyanide complex,
from 0.3 g/l to 5 g/l of cadmium in the form of a cyanide or organic complex,
from 0.5 g/l to 15 g/l of carbon nanotubes,
from 3 g/l to 50 g/l of free potassium cyanide,
from 1 g/l to 200 g/l of total cyanide,
from 5 g/l to 100 g/l of organic complexing agent,
from 0.01 ml/l to 50 ml/l of a wetting agent,
   as well as optionally
from 0.01 mg/l to 100 mg/l of brightener
from 2 mg/l to 20 mg/l of depolarizer.

According to the invention, said galvanic bath does not contain any surfactant used for dispersing the carbon nanotubes.

Thus, there is no risk that such agents degrade and be detrimental to the quality of bath.

The galvanic bath according to the invention is applied in a method for galvanic deposition of a composite material on a substrate comprising the steps:
preparation of a bath as described above,
treatment of said bath with ultrasound,
electrolysis in said bath comprising an anode and the substrate forming a cathode,
   said method not comprising any step for thermal pretreatment of the bath or of the carbon nanotubes.

The method according to the invention also does not comprise any acid pretreatment of the carbon nanotubes.

The method according to the invention also does not comprise any step for adding a surfactant used for dispersing the carbon nanotubes.

The treatment of the bath with ultrasound is carried out for a duration comprised between 2 and 24 hours.

During the electrolysis, the bath is conventionally subject to mechanical stirring, at a temperature comprised between 45° C. and 75° C. The current density is preferably comprised between 0.6 A·dm² and 2 A·dm² and more preferentially between 0.6 A·dm² and 1.5 A·dm².

The anode is preferably an anode in platinized titanium or any other suitable anode.

The cathode is formed by a substrate on which the composite material has to be deposited. This substrate may be a metal or any suitable substrate, and may have been subject to various suitable surface treatments.

Advantageously, it is possible to deposit the gold/copper/cadmium/carbon nanotube material on a sub-layer based on nickel and phosphorus, containing from 1 to 20% by weight of phosphorus, and preferably from 10 to 15% by weight of phosphorus. The sub-layer was also subject to a heat treatment at a temperature comprised between 200° C. and 500° C. for one hour, and preferably between 250° C. and 300° C. Such a combination gives the possibility of obtaining parts having a galvanic coating of a composite gold/copper/cadmium/carbon nanotubes material having low friction coefficients (less than 0.2 μm) and having improved resistance to wear (+200%).

The thickness of the deposited composite material is preferably comprised between 100 nm and 10 μm and more preferentially between 0.5 μm and 10 μm.

The method according to the invention gives the possibility of obtaining a part having electric resistivity of less than 10 mΩ, comprising a galvanic coating of a composite material comprising between 55% and 80% by weight of gold, between 10% and 30% by weight of copper, between 5% and 10% by weight of cadmium and between 0.1% and 5% by weight of carbon nanotubes, based on the total weight of the composite material. Advantageously, a part according to the invention has an electric resistivity of less than 5 mΩ.

This part may be used for example in the fields of clockmaking for decoration, jewelry, or electronics for producing electric contacts. More particularly, the invention may be applied to internal clockwork movement parts, to clockwork wheels, to plates, to external parts, electric contact tracks, plugs, integrated circuits, sockets or other electric/electronic circuits allowing the passing of an electric current.

The following examples are illustrated in the present invention without however limiting its scope.

### EXAMPLES

A bath according to the invention was prepared according to the following composition:

| | | |
|---|---|---|
| Gold, in the form of a cyanide complex | 4 | g/l |
| Copper in the form of a cyanide complex | 60 | g/l |
| Cadmium in the form of a cyanide | 0.6 | g/l |
| Free potassium cyanide | 25 | g/l |
| Potassium salt of hydroxy-ethyl-imino-diacetic acid | 20 | g/l |
| Wetting agents: saturated fatty acid | 5 | ml/l |
| amido-propyl-dimethyl-aminoxides (with 11 to 17 carbons) | | |
| Potassium carbonate | 20 | g/l |
| Carbon nanotubes | 2 | g/l |

pH = 10.5

During the electrolysis, the bath is conventionally subject to mechanical stirring, at a temperature of 65° C., with a current density of 0.8 A·dm².

The imposition time is 4 minutes.

As a comparison, a bath based on gold and cobalt was prepared according to the following composition:

| | | |
|---|---|---|
| Gold, in the form of a cyanide complex | 4 | g/l |
| Cobalt in the form of citrate | 1.5 | g/l |
| Monosodium citrate | 150 | g/l |
| Carbon nanotubes | 2 | g/l |
| Fluorinated wetting agent | 5 | ml/l |

pH = 10.5

During the electrolysis, the bath is conventionally subject to mechanical stirring, at a temperature of 35° C., with a current density of 0.8 A·dm².

The imposition time is 4 minutes.

Brass plates of 5 cm² were subject to electrolysis in these baths.

The brass plates may be already coated with a nickel coating. This pretreatment allows protection of the electrolytes during the introduction of the parts (dissolution of copper and of nickel). This treatment may also harden the proposed substrate. However, this pretreatment is optional.

The composite materials deposited for a current density of 0.8 A·dm² for 4 minutes at 65° C. have the following composition:

| | |
|---|---|
| Gold | 58% |
| Copper | 33% |
| Cadmium | 8% |
| Nanotubes | 1.9% |

Friction tests are conducted by means of a tribometer.

The tribometer calculates the friction coefficient μ by means of the measured tangential force, as defined by the ratio between the tangential force and the normal force for a mass applied on the deposits of 5N.

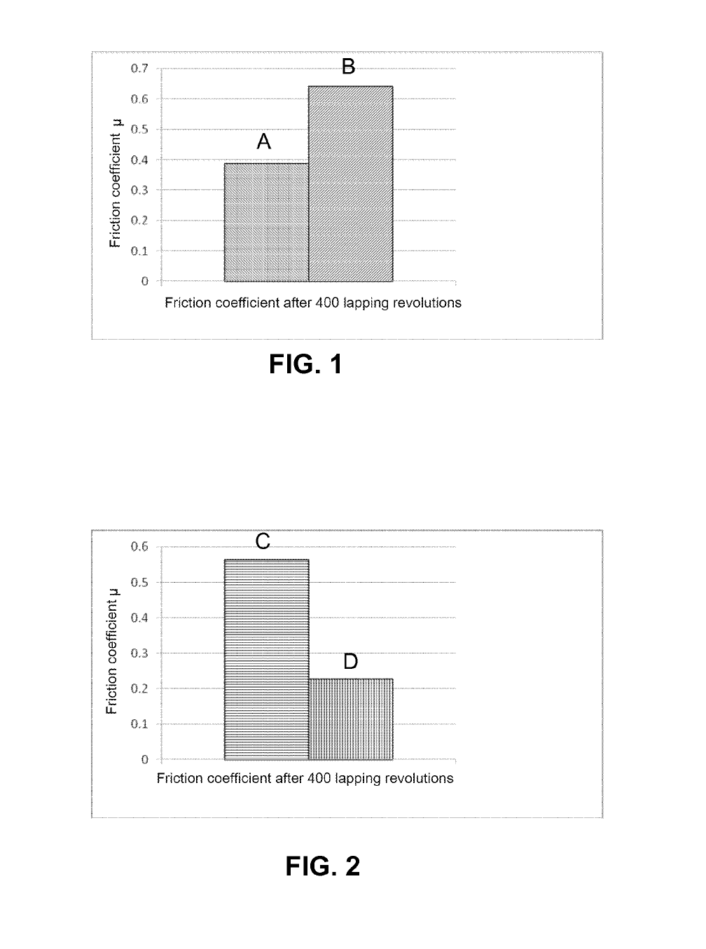

The results are illustrated in FIGS. 1 and 2, the friction coefficient being measured after 400 lapping revolutions.

Graph A of FIG. 1 corresponds to the gold/cobalt alloy and graph B of FIG. 1 corresponds to the gold/cobalt/multi-walled carbon nanotube composite material.

Graph C of FIG. 2 corresponds to the gold/copper/cadmium alloy and graph D of FIG. 2 corresponds to the gold/copper/cadmium/multi-walled carbon nanotube composite material.

FIGS. 1 and 2 show that surprisingly and unexpectedly, the use of multi-walled carbon nanotubes in a gold/copper/cadmium coating gives the possibility of reducing the friction coefficient while this coefficient is increased in the case of a gold-cobalt material.

Another test was conducted by providing, under the layer of the gold/copper/cadmium/multi-walled carbon nanotube composite material, a sub-layer based on nickel and phosphorus (12% by weight) having undergone heat treatment between 250° C. and 300° C. for one hour. The friction coefficient of the coating in gold/copper/cadmium/multi-walled carbon nanotube composite material is then further lowered by 0.15 μm.

A material which has a lower friction coefficient generally expresses better capability for lubrication during frictional stresses. During the use of this kind of material, this is expressed by a significant lowering of the required/spent energy during the use of the system.

Measurements of resistance to wear were also conducted, over a total sliding distance of 314 m, by measuring the worn groove formed during the friction test. For a copper in a gold/copper/cadmium alloy with a thickness of 6 μm, the depth of the measured worn groove is 3 μm. For a coating in a gold/copper/cadmium/multi-walled carbon nanotube alloy with a thickness of 2 μm, the depth of the measured worn groove is 1 μm. For a coating in a gold/copper/cadmium/multi-walled carbon nanotube alloy with a thickness of 2 μm deposited on a sub-layer of nickel and of phosphorus (12% by weight) having been subject to heat treatment between 250° C. and 300° C. for one hour, the depth of the measured worn groove is 0.

Measurements of tribo-resistivity were also conducted by means of a tribometer.

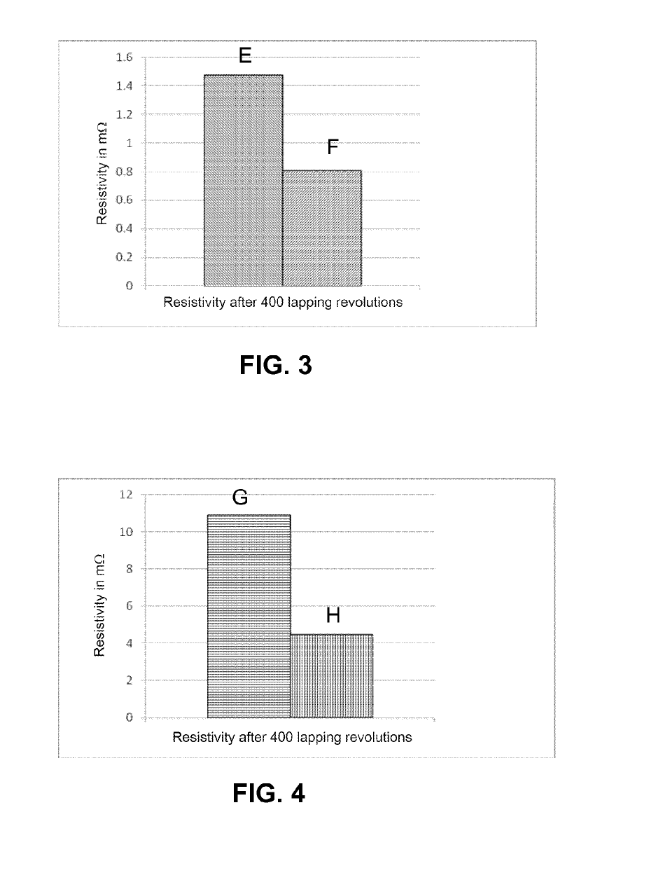

The results are illustrated in FIGS. 3 and 4, the resistivity being measured after 400 lapping revolutions.

Graph E of FIG. 3 corresponds to the gold/cobalt alloy and graph F of FIG. 3 corresponds to the gold/cobalt/multi-walled carbon nanotube composite material.

Graph G of FIG. 4 corresponds to the gold/copper/cadmium alloy and graph H of FIG. 4 corresponds to the gold/copper/cadmium/multi-walled carbon nanotube composite material.

The resistivity is quasi 4 mΩ with the composite material obtained according to the invention, while it is 800 mΩ for the material based on gold and cobalt.

This effect is all the more unexpected since application WO 2008/063148 describes that the multi-walled carbon nanotubes in copper alloys have low electric conductivity.

The galvanic baths according to the invention give the possibility of obtaining parts with improved properties. Notably, the resistivity is reduced and is preferably less than 5 mΩ, and the frictional coefficient is reduced.

1-10. (canceled)

11. A galvanic bath for electrolytic deposition of a composite material based on gold, copper and cadmium, comprising, in cyanide form, gold, copper and cadmium, wherein said galvanic bath has a pH of more than 7, and further comprises carbon nanotubes, and wherein said galvanic bath does not contain any surfactant used for dispersing the carbon nanotubes.

12. The galvanic bath according to claim 11, wherein the carbon nanotubes are multi-walled carbon nanotubes.

13. The galvanic bath according to claim 11, wherein it contains from 0.5 g/l to 20 g/l of gold metal, 6 g/l to 70 g/l of copper metal, 0.3 g/l to 5 g/l of cadmium metal, and from 0.5 g/l to 20 g/l of carbon nanotubes, so as to obtain a composite material comprising between 55% and 80% by weight of gold, between 10% and 30% by weight of copper, between 5% and 10% by weight of cadmium, and between 0.1% and 5% by weight of carbon nanotubes, based on the total weight of the composite material.

14. The galvanic bath according to claim 11, wherein it further comprises from 3 g/l to 50 g/l of free potassium cyanide.

15. The galvanic bath according to claim 11, wherein it has a pH which is comprised between 9 and 11.

16. The galvanic bath according to claim 11, wherein the carbon nanotubes have a length comprised between 0.5 μm and 10 μm, and a diameter comprised between 5 nm and 20 nm.

17. A method for galvanic deposition of a composite material on a substrate comprising the steps:
preparation of a galvanic bath for electrolytic deposition of a composite material based on gold, copper and cadmium, comprising, in cyanide form, gold, copper and cadmium, wherein said galvanic bath has a pH of more than 7, and further comprises carbon nanotubes, and wherein said galvanic bath does not contain any surfactant used for dispersing the carbon nanotubes,
treatment of said galvanic bath with ultrasound,
electrolysis in said galvanic bath comprising an anode and the substrate forming a cathode,
said method not comprising any thermal pretreatment step of the bath.

18. A part having an electric resistivity of less than 10 mΩ, comprising a galvanic coating of a composite material comprising between 55% and 80% by weight of gold, between 10% and 30% by weight of copper, between 5% and 10% by weight of cadmium and between 0.1% and 5% by weight of carbon nanotubes, based on the total weight of the composite material.

19. The part according to claim 18, wherein it comprises a sub-layer comprising nickel and between 1% and 20% by weight of phosphorus, and having been subject to a heat treatment at a temperature comprised between 200° C. and 500° C.
